(19) United States
(12) Patent Application Publication
(10) Pub. No.: US 2016/0237180 A1
(43) Pub. Date: Aug. 18, 2016

(54) REACTOR FOR INLINE PROCESSING

(71) Applicants: Robert L. Sargent, Chelmsford, MA (US); Michael D. Callaghan, Minneapolis, MN (US)

(72) Inventors: Robert L. Sargent, Chelmsford, MA (US); Michael D. Callaghan, Minneapolis, MN (US)

(21) Appl. No.: 14/997,638

(22) Filed: Jan. 18, 2016

Related U.S. Application Data
(60) Provisional application No. 62/105,086, filed on Jan. 19, 2015.

(51) Int. Cl. C08F 2/01; C08F 2/48

(52) U.S. Cl. CPC C08F 2/01; C08F 2/48

(57) ABSTRACT

A reactor for in-line processing includes a housing coupled to a geometrically reflective structure. A plurality of radiation sources, such as LED lights, as disposed in the housing and arranged such that they project their radiation into the geometrically reflective structure. A material to be cured is to be exposed to radiation as it passes though the geometrically reflective structure.

### PRIORITY

This application claims priority under 35 U.S.C. §119 (e) to, and hereby incorporates by reference, U.S. Provisional Application No. 62/105,086, filed 19 Jan. 2015.

### BACKGROUND

In manufacturing processes, products, such as photopolymers (e.g., acrylics), are desired to be cured by exposure to radiation (e.g. UV light). There is a need to provide devices, systems and methods to provide radiation exposure for curing products in an in-line manner.

### SUMMARY

A reactor for in-line processing includes a housing coupled to a geometrically reflective structure. A plurality of radiation sources, such as LED lights, as disposed in the housing and arranged such that they project their radiation into the geometrically reflective structure. A material to be cured is to be exposed to radiation as it passes though the geometrically reflective structure.

### BRIEF DESCRIPTION OF THE DRAWINGS

FIG. 1 is a perspective view of a reactor for in-line processing according to certain embodiments.

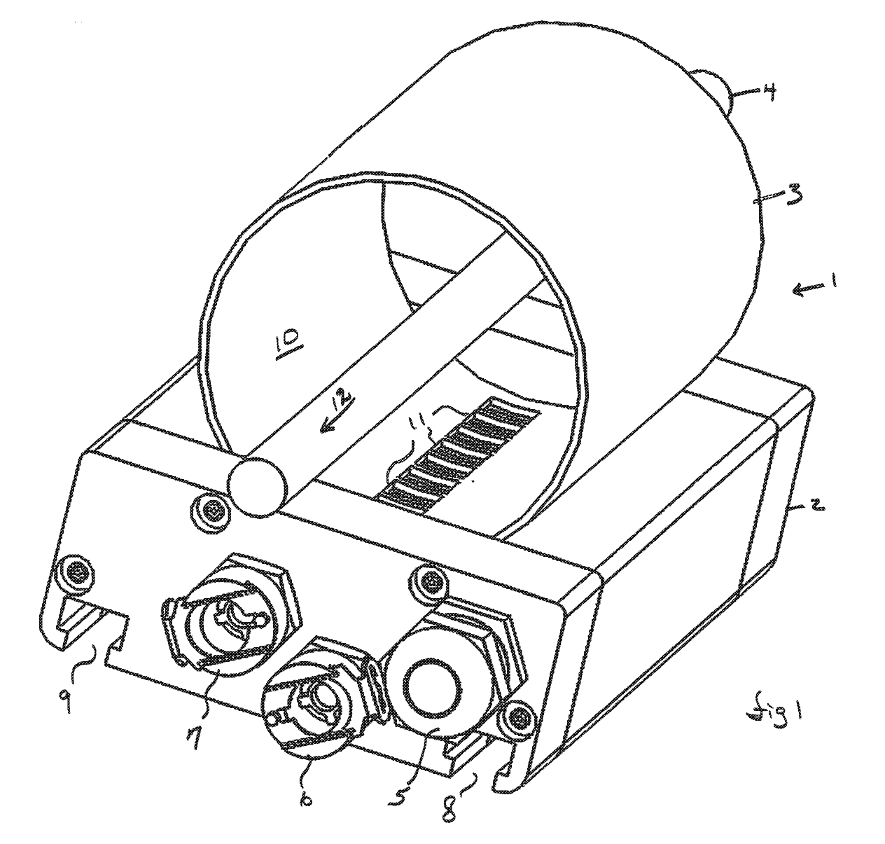

FIG. 2 is another perspective view of a reactor for in-line processing according to certain embodiments.

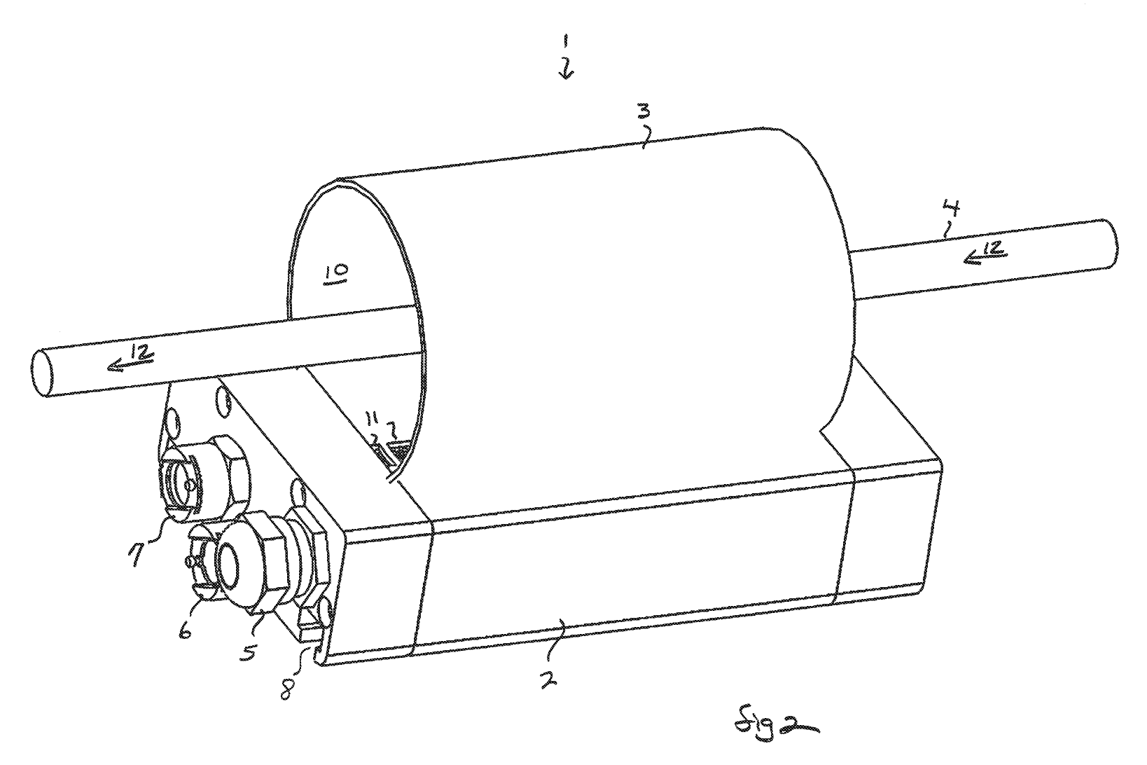

FIG. 3 is a further perspective view of a reactor for in-line processing according to certain embodiments.

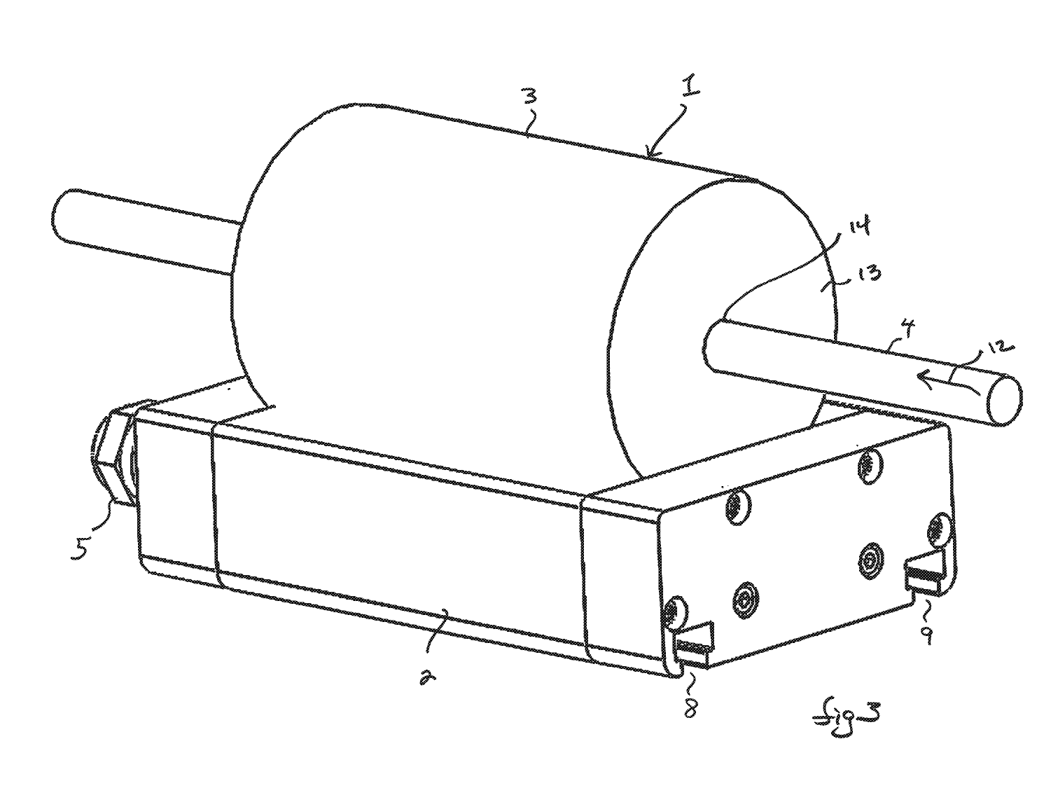

FIG. 4 is an additional perspective view of a reactor for in-line processing according to certain embodiments.

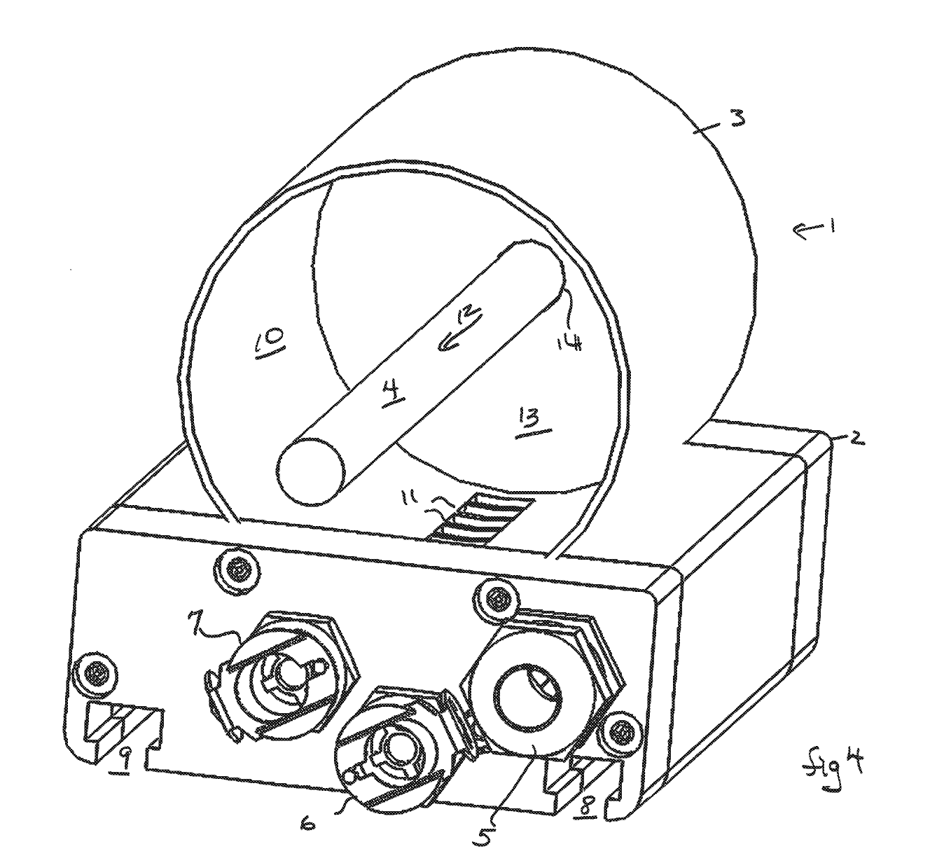

FIG. 5 is a further additional perspective view of a reactor for in-line processing according to certain embodiments.

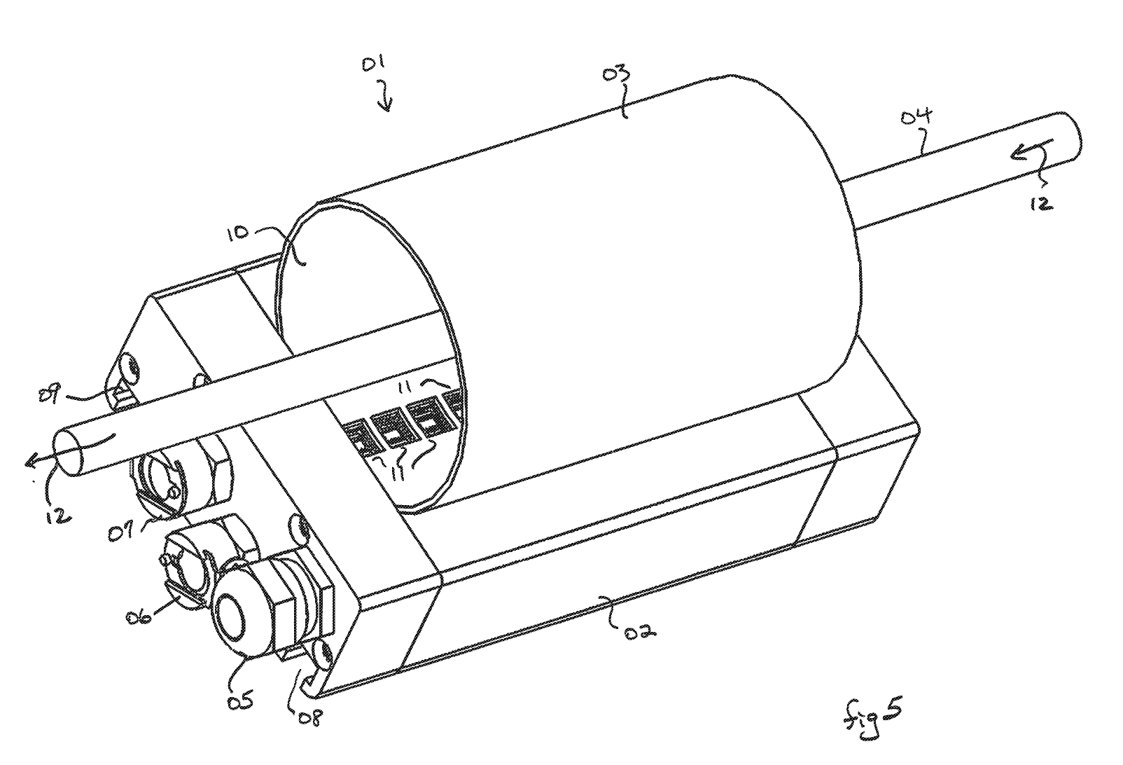

### DETAILED DESCRIPTION

Depicted in the Figures is a reactor for in-line processing 01, which includes a housing 02, geometrically reflective structure 03, and a material 04 to be cured such as a photopolymer (e.g., acrylic), which is to be exposed to radiation.

The housing includes connections for power such as electricity 05, and coolant ingress 06 and egress 07. The electrical connection may conduct electrical current to power the light source and may also include conductive materials, e.g., fiber optic, to transmit digital information to a processing unit, if a processing unit is present.

The housing has at least one, or as shown, a plurality of light (electromagnetic) sources 11, such as LEDs, optionally emitting UV light. However, wavelengths of the emitted radiation will be determined by the properties of the material to be cured. Optionally, slots 08, 09 may be present in the housing for mounting to rails or other devices downstream from where the material to be cured is being formed.

The reflective structure, as depicted, is generally cylindrical in configuration with an interior surface 10 suitable for reflecting light to a satisfactory even quantity upon the substrate to be cured. However, a person of ordinary skill in the art will readily realize that other geometric shapes may be suitable, depending upon the intensity of radiation emitted and the geometry of the material to be cured, which is the cylinder or rod in the figures.

One suitable material for the reflective structure is aluminum polished to reflect light. However, any material having reflective characteristics can be used for this purpose.

Optionally, the material to be cured is passed through an opening 14 present in a closed end 13 of the reflective structure, the opening having a close tolerance to the outer periphery of the material to be cured to minimize escape of the emitted light and premature curing.

The material to be cured may optionally be rotated as it is conveyed in the direction indicated by arrow 12 through the reflective structure.

While shown as being horizontal, the embodiment may actually be deployed vertically, such as below or downstream from an extruder forming the material to be cured.

A listing of the elements appearing in the figures is as follows:
01. Reactor for in-line processing
02. Housing
03. Reflective cylinder
04. Material to be cured
05. Electrical connections
06. Coolant ingress
07. Coolant egress
08. Rail slot
09. Rail slot
10. Reflective surface
11. Light source
12. Direction of travel
13. Closed end
14. Opening

1. A reactor for in-line processing as described and disclosed herein.

2. A method of manufacturing the reactor of claim 1.

3. A method of curing a polymer by conveying said polymer through the reactor of claim 1.
